(19) United States
(12) Patent Application Publication
(10) Pub. No.: US 2017/0279789 A1
(43) Pub. Date: Sep. 28, 2017

(54) INFORMATION PROCESSING METHOD AND SYSTEM, ELECTRONIC DEVICE, AND SERVER

(71) Applicant: Lenovo (Beijing) Limited, Beijing (CN)

(72) Inventors: Tao Miao, Beijing (CN); Hui Xu, Beijing (CN)

(21) Appl. No.: 15/469,858

(22) Filed: Mar. 27, 2017

(30) Foreign Application Priority Data
Mar. 28, 2016 (CN) 201610183571.2

(51) Int. Cl. H04L 29/06; G06F 21/62; H04W 12/08; H04L 9/32; H04L 29/08

(52) U.S. Cl. CPC H04L 63/083; H04L 9/3226; H04L 63/102; H04L 67/125; H04L 67/34; H04L 29/06; H04L 63/205; H04W 12/08; G06F 21/6227; G06F 21/6218; G06F 2221/2141

(57) ABSTRACT

One embodiment provides a method, including: identifying an attempt to access an application installed on an information handling device, a request; receiving, in response to the attempt to access the application, a coded data set at the information handling device; identifying a target application associated with the coded data set; and causing the target application to access the coded data set. Other aspects are described and claimed.

### CLAIM FOR PRIORITY

This application claims priority to Chinese Application No. 201610183571.2, filed on Mar. 28, 2016, which is fully incorporated by reference herein.

### FIELD

The subject matter described herein relates to the field of information security management, more specifically, it relates to an information processing method and system, an electronic device, and a server.

### BACKGROUND

At present, when a user logs into a network account and modifies the information thereof, or performs events such as a network transaction, the user is often required to enter a verification code, for example, the verification code contained in the verification information fed back by a server to an electronic device that is bound to the user in advance. Subsequently, the user can successfully log into a corresponding interface to complete the desired operations, thereby preventing harm to the vital interests of the user caused by intrusion of invalid users.

### BRIEF SUMMARY

In summary, one aspect provides a method, comprising: identifying an attempt to access an application installed on an information handling device; receiving, in response to the attempt to access the application, a coded data set at the information handling device; identifying a target application associated with the coded data set; and causing the target application to access the coded data set.

Another aspect provides an information handling device, comprising: a processor; a memory device that stores instructions executable by the processor to: identify an attempt to access an application installed on an information handling device; receive, in response to the attempt to access the application, a coded data set at the information handling device; identify a target application associated with the coded data set; and cause the target application to access the coded data set.

A further aspect provides a product, comprising: a storage device that stores code, the code being executable by a processor and comprising: code that identifies an attempt to access an application installed on an information handling device; code that receives, in response to the attempt to access the application, a coded data set at the information handling device; code that identifies a target application associated with the coded data set; and code that causes the target application to access the coded data set.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a schematic flow diagram illustrating an exemplary information processing method.

FIG. 2 is a schematic flow diagram illustrating an exemplary information processing method.

FIG. 3 is a schematic flow diagram illustrating an exemplary information processing method.

FIG. 4 is a schematic flow diagram illustrating an exemplary information processing method.

FIG. 5 is a structural schematic block diagram illustrating an exemplary electronic device.

FIG. 6 is a structural schematic block diagram illustrating an exemplary server.

FIG. 7 is a structural schematic diagram illustrating an exemplary information processing system.

### DETAILED DESCRIPTION

The technical solutions contained in the embodiments of the present application are described in detail clearly and completely hereinafter with reference to the accompanying drawings for the embodiments of the present application. It is apparent that the described embodiments are only some of the embodiments of the present application, and not all the embodiments of the present application. All other embodiments obtained by a person skilled in the art, based on the embodiments of the present application without any creative effort, will fall within the scope of protection of the present application.

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

In practical applications, as long as an information reading function is requested for various applications in an electronic device, the verification information fed back by a server to the electronic device can be read. Hence, once a malicious application is installed on the electronic device, the authentication information received by the electronic device will be stolen, leading to threats to the security of the accounts bound to the electronic device, and thus causing leakage of personal information of the user and property damage of the user.

An embodiment provides an information processing method and system, an electronic device, and a server. Since the verification information fed back by the server received by the electronic device includes not only the verification code, but also the application identification information, an embodiment only allows the target application that matches the received application identification information to successfully read the verification information. An embodiment then obtains the verification code in the verification information to complete subsequent operations. However, other applications in the electronic device that do not match the received application identification information, cannot read the verification information received by the electronic device, and thus cannot learn of the corresponding verification code. Therefore, an embodiment may prevent leakage of personal information and damage to property of the user caused by a malicious application stealing the verification code.

The illustrated example embodiments will be best understood by reference to the figures. The following description is intended only by way of example, and simply illustrates certain example embodiments.

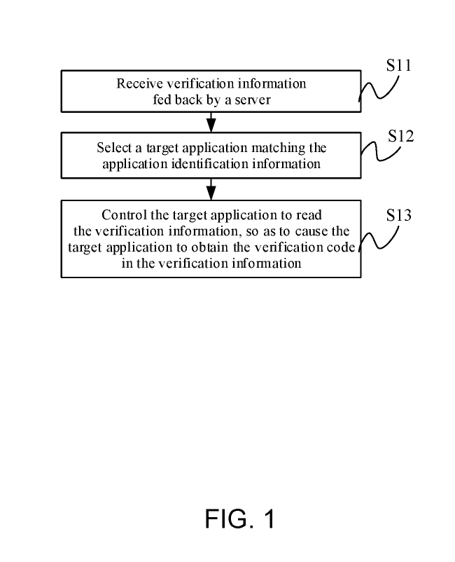

Referring now to FIG. 1, a flow diagram of an information processing method according to an embodiment is illustrated. In an embodiment, the method may be applied to electronic devices, e.g., electronic devices capable of logging into personal accounts of users, such as a mobile phone, iPad, and computer, but is not limited thereto.

At step S11, an embodiment may receive verification information fed back by a server. In an embodiment, the verification information may include, but is not limited to, application identification information and a verification code, which can be determined according to actual requirements. The application identification information may include a target application signature and/or target application package name (“package name”), and may also include other contents according to actual requirements.

Taking the ANDROID system as an example, in practical applications, the ANDROID system requires that each ANDROID application (i.e., an application program) must be digitally signed in order to be installed in the system. That is, if an ANDROID application is not digitally signed, the ANDROID application cannot be installed on the system. Hence, the ANDROID system identifies establishment of a trust relationship between an author that develops an application and the application through a digital signature, rather than decides which applications can be finally installed by the user. Generally, this digital signature is completed by the author of the application, does not need to be authenticated by an official certificate signature authority, and is only used for self-certification of the application package. ANDROID is a registered trademark of Google Inc. in the United States and other countries

On this basis, any application installed in an electronic device where a system (such as, the ANDROID system, but is not limited thereto) is installed, has an application signature (such as, the aforementioned digital signature). However, it should be noted that since the application signature may be set by the author of the application, the application signatures of multiple applications are often the same in practical applications. However, with regard to the target application package name, it should be noted that the application package name of each application program is different. That is, the various applications may be differentiated by different application package names.

In an embodiment, when a user needs to log into a personal account, such as a bank account, an email account or other payment accounts, or to further make payment or modify information, in order to ensure the safeties of property and important information of the user, information verification generally needs to be performed at the current moment. At this time, the user generally needs to trigger a verification information acquisition request on a corresponding interface of the electronic device, thereby sending verification request information to the server of the current application.

Subsequently, the server feeds back corresponding verification information based on the verification request information sent by the electronic device. Because the server is a server of the current application, if the current application is a bank client, the server is a server of the bank; if the current application is a Q email mailbox, then the server is also a Q server. Therefore, in an embodiment, the server that receives the verification request information has the application identification information used for indicating the identity of the current application, such as the application signature and application package name of the current application.

In an embodiment, the verification code in the verification information fed back by the server may be generated at random or generated according to a preset rule. The generating mode of the verification code is not limited and the output form of the verification code is not limited, either, which may be digits, letters, figures, or the like. It should also be noted that the feedback mode and output mode of the verification information fed back by the server are not limited and may be a short message, voice audio, or the like, and may be determined according to the actual situations.

At step S12, an embodiment may select a target application matching the application identification information. In conventional applications, the various applications installed in an electronic device usually read the short messages, call content or voice audio content, contact list, and location information, etc. of the electronic device. However, the existing verification information only contains the verification code. This will easily lead to some malicious applications stealing the verification code for logging into the current application fed back by the server, thereby causing harm to the vital interests of the user.

To solve the aforementioned problem, an embodiment enables the verification information fed back by the server to include not only the verification code, but also the application identification information. In such a way, after receiving the verification information, the system of the electronic device can screen applications allowed by the system to read the verification information according to the application identification information, thereby preventing malicious applications from reading the verification information.

In an embodiment, when the system detects that the applications installed in the electronic device initiate read requests, an embodiment may verify whether the identification information of the applications that initiated the read requests is consistent with the application identification information fed back by the server one by one. If consistent, then the applications that initiated the read requests may be regarded as the target applications.

In an embodiment, the present application may compare the application identification information with the identification information of an application currently installed on the electronic device. When the comparison result is that the identification information of the application is consistent with the application identification information fed back by the server, the application is regarded as the target application matching the application identification information.

It should be noted that the selection mode of the target application matching the application identification information fed back by the server is not limited to the two modes listed above.

At step S13, an embodiment may control the target application to read the verification information so as to cause the target application to obtain the verification code in the verification information. In an embodiment, after it is determined that the system allows the target applications to read the verification information fed back by the server, these target applications are directly controlled to read the verification information, thereby allowing the target applications to obtain the verification code in order to satisfy the user requirements.

In step S13, according to an embodiment, the system may directly send the received verification information to the target application. Furthermore, after receiving the verification information and parsing out the verification code contained therein, the target application may directly output the verification code such that the user inputs the verification code to a corresponding position on a current interface of the target application. In an embodiment, after parsing out the verification code, the target application may also directly input the same to the corresponding position on the current interface so that the interface user uses the target application to log into a personnel account or complete corresponding transactions, etc. The mode of obtaining the verification code by the target application is not limited in the present application.

Therefore, in an embodiment, after the server receives the verification request information sent by the electronic device, the verification information fed back by the server includes not only the verification code, but also the application identification information. This ensures that an embodiment only allows the target application that matches the received application identification information to successfully read the verification information. The target application can then obtain the verification code in the verification information to complete subsequent operations. However, other applications in the electronic device that cannot match the received application identification information cannot read the verification information received by the electronic device and thus cannot learn of the corresponding verification code. This prevents leakage of personal information and damage to property of the user caused by the malicious application stealing the verification information such as the verification code, and ensuring the safety of the vital interests of the user.

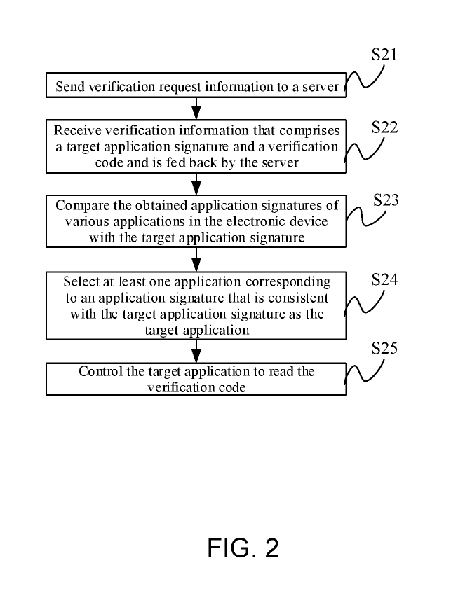

Referring to FIG. 2, a flow diagram of an information processing method according to an embodiment is illustrated. The method may be applied to electronic devices such as the mobile phone, tablet, iPad®, and computer. In an embodiment, the verification information fed back by the server comprises an application signature as an example.

At step S21, an embodiment may send verification request information to a server. In an embodiment, the verification request information may be sent when a user starts or triggers a current application of the electronic device. For example, when the user uses a bank client to make a transfer or payment, a corresponding interface generally outputs a verification request button and the user may trigger the verification request button to send verification request information to the bank server.

At step S22, an embodiment may receive verification information comprising a target application signature and a verification code fed back by the server. In an embodiment, the target application signature may be determined for the application that sends the verification request information to the server. As previously mentioned, the servers of different applications are usually different. Therefore, when any one of the applications sends the verification request information, since the verification request information is received by a server corresponding to the said application, the server may directly feedback the application signature of the application, i.e., the target application signature and the generated verification code to the electronic device.

Taking Alipay® as an example, the target application signature fed back by the server may be a Hash value of the application signature information of Alipay®, but is not limited thereto. The Hash value refers to mapping a binary value of arbitrary length into a smaller binary value of fixed length by using a Hash algorithm, and is usually a numeric value obtained by logic operation based on the data of the content of the file. The Hash values of different files are different.

It should be noted that the aforementioned verification information does not comprise the target application package name at this time. In such a way, in an embodiment, the system may allow a plurality of applications to read the verification information according to actual requirements. Therefore, whether the application identification information fed back by the server comprises the target application package name may be determined according to the actual requirements.

At step S23, an embodiment may compare the obtained application signatures of various applications in the electronic device with the target application signature.

At step S24, an embodiment may select at least one application corresponding to an application signature that is consistent with the target application signature as the target application. In an embodiment, after the system of the electronic device receives the target application signature fed back by the server, some or all of the applications installed in the electronic device may initiate a verification code acquisition request to the system. At this time, in an embodiment, the system of the electronic device may acquire the application signature of a corresponding application according to the detected verification code acquisition request. An embodiment may then compare the acquired application signature with the target application signature, thereby determining whether the application is the target application, i.e., the application allowed by the system to read the verification code. In view of the above, the mode of determining the target application in the electronic device is not limited to the modes described in Step S23 and Step S24.

At step S25, an embodiment may control the target application to read the verification code. In an embodiment, after reading the verification code fed back by the server, the target application may directly display the same on a current interface of the electronic device and the user may input the same to a corresponding position on a corresponding interface of the target application by means of copy-paste or direct entering. The mode of obtaining the verification code by the target application is not limited in the present application.

Similar to the aforementioned example of AliPay®, in an embodiment, the system of the electronic device only allows applications that conform to the received Hash value to read the short message fed back by the server. Moreover, with regard to the electronic device, which does not adopt the information processing method provided, the short message received thereby generally comprises some Hash values that have no meaning but does not influence the normal use of the electronic device.

Therefore, in an embodiment, after the electronic device sends verification request information to the server, the verification information fed back by the server includes not only the verification code, but also the target application signature. In such a way, the short message received by the system of the electronic device comprises the target application signature and the verification code. Hence, only when the applications of the electronic device have the target application name, these applications can obtain the verification code to complete subsequent operations, thereby preventing leakage of personal information and damage to property of the user caused by a malicious application stealing the verification code.

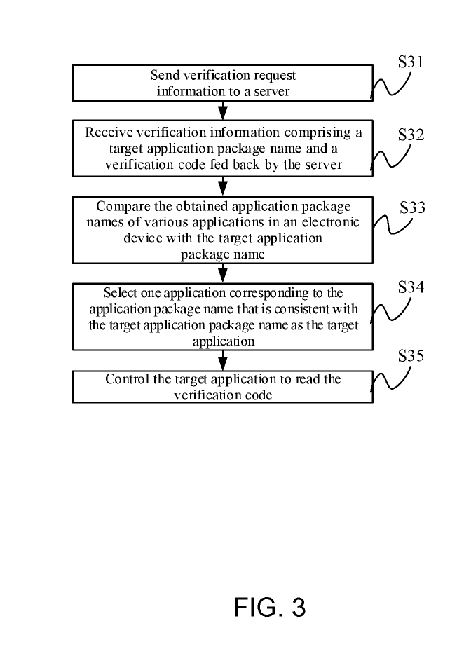

Referring to FIG. 3, a flow diagram of an information processing method according to an embodiment is illustrated. This method may also be applied to the electronic devices such as the mobile phone, table, iPad®, and computer. Moreover, in an embodiment, the verification information fed back by the server to the electronic device comprises a target application package name and a verification code, thereby ensuring that only one application that has the target application package name can obtain the verification code.

At step S31, an embodiment may send verification request information to a server. At step S32, an embodiment may receive verification information, comprising a target application package name and a verification code, fed back by the server. As previously mentioned in the embodiments, it can be known that the application package names of different applications are different. This means that the application capable of reading the verification information in the electronic device is unique, thereby further improving the safety of the verification information and guaranteeing the safety of the vital interests of the user.

In an embodiment, the verification information fed back by the server may only comprise the target application package name and the verification code, but does not comprise the target application signature. In an embodiment, the verification information may also comprise both the target application signature and the target application package name. In an embodiment, the selection of the target application is subject to the target application package name, that is, the system can in the end allow only one application to read the verification information.

At step S33, an embodiment may compare the obtained application package names of various applications in the electronic device with the target application package name. At step S34, an embodiment may select one application corresponding to an application package name that is consistent with the target application package name as the target application. At step S35, an embodiment may control the target application to read the verification code.

Therefore, in an embodiment, by causing the server to add a target application package name while feeding back the verification code to the electronic device, the verification short message received by the electronic device comprises both the target application package name and the verification code, thereby adding a verification step for the various applications of the electronic device to read the verification code. Moreover, since the particularity of the target application package name determines that the system of the electronic device in the present embodiment allows only one application to be able to read the verification code and refuses other applications to read the verification code, leakage of property and important information of the user resulting from leakage of the verification code caused by those other applications is prevented.

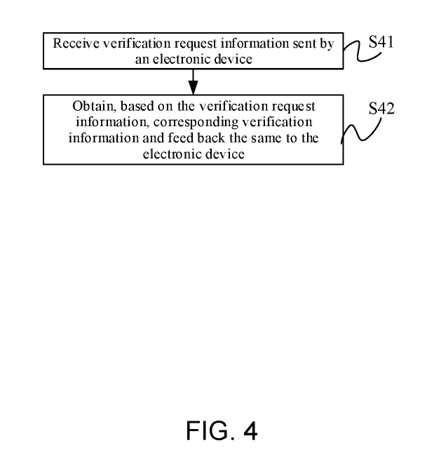

Referring to FIG. 4, a flow diagram of an information processing method according to an embodiment is illustrated. In an embodiment, the method in the may be applied to a server.

At step S41, an embodiment may receive verification request information sent by an electronic device. At step S42, an embodiment may obtain, based on the verification request information, corresponding verification information and feedback the same to the electronic device.

In an embodiment, the verification information may include application identification information and a verification code. In an embodiment, the application identification information may include a target application signature and/or a target application package name. Whether the application identification information includes only the target application signature or the target application package name, or includes both the target application signature and the target application package name, may be determined according to actual requirements. The aforementioned mode of obtaining the verification information by the server is not limited in the present application; for example, the verification code of the verification information may be generated at random or generated according to a preset rule, etc. Moreover, the mode of feeding back the verification information to the electronic device by the server is not limited either and may be determined according to the specific output mode of the verification information.

In an embodiment, after the server receives the verification request information sent by the electronic device, the verification information fed back to the electronic device also includes application identification information besides the verification code. An embodiment thereby defines the applications of the electronic device that can read the verification information, and prevents leakage of personal information and damage to property of the user caused by a malicious application stealing the verification code.

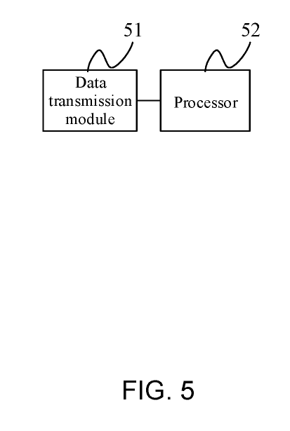

Referring to FIG. 5, a structural schematic diagram of an electronic device according to an embodiment is illustrated. The electronic device may include, but is not limited to, a mobile phone, tablet, iPad®, computer, or the like. In an embodiment, the electronic device may further include: a data transmission module 51 which used to receive verification information fed back by a server,

In an embodiment, the verification information may include application identification information and a verification code. Moreover, the application identification information may include a target application signature and/or target application package name. The contents contained in the verification information and expression forms are not limited in the present application.

In an embodiment, the electronic device may further include a processor 52 used to select a target application matching the application identification information. In an embodiment, the processor may also control the target application to read the verification information so as to cause the target application to obtain the verification code in the verification information.

In an embodiment, when the application identification information received by the system of the electronic device includes a target application signature, but does not include a target application package name, in order to select the target application, the processor 52 may compare the obtained application signatures of the various applications in the electronic device with the target application signature and select at least one application corresponding to the application signature that is consistent with the target application signature as the target application.

Similarly, in an embodiment, when the application identification information at least includes a target application package name, in order to select the target application, the processor 52 may also acquire the application package names of the various applications in the electronic device and select the application corresponding to the application package name that is consistent with the target application package name as the target application.

It should be noted that, the mode of selecting a target application, i.e., an application allowed by the electronic device to read the verification information received thereby, is not limited to the aforementioned method.

Therefore, in an embodiment, after the electronic device sends verification request information to the server, the received verification information that is fed back by the server includes not only the verification code, but also the application identification information. This ensures that only the target application that matches the received application identification information can read the verification information and obtain the verification code in the verification information. However, other applications in the electronic device that do not match the received application identification information cannot read the verification information received by the electronic device and cannot therefore learn of the corresponding verification code. This prevents leakage of personal information and damage to property of the user caused by a malicious application stealing the verification code.

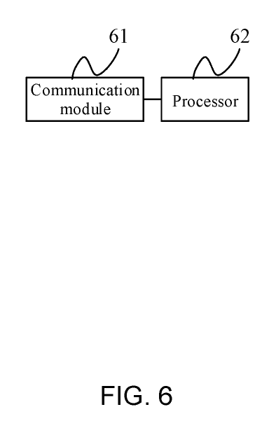

Referring to FIG. 6, a structural schematic diagram of a server according to an embodiment is disclosed. The server may include: a communication module 61, used to receive verification request information sent by an electronic device. In an embodiment, the verification request information may be sent when a user starts or triggers a current application of the electronic device. In an embodiment, the server may include a processor 62, used to obtain, based on the verification request information, corresponding verification information and feedback the same to the electronic device through the communication module 61.

In an embodiment, the verification information may include application identification information and a verification code. Moreover, the application identification information may include a target application signature and/or target application package name.

Therefore, in an embodiment, after the server receives the verification request information sent by the electronic device, the verification information fed back to the electronic device also includes application identification information besides the verification code. The application identification information thereby defines the applications of the electronic device that can read the verification information, thereby preventing leakage of personal information and damage to property of the user caused by a malicious application stealing the verification code.

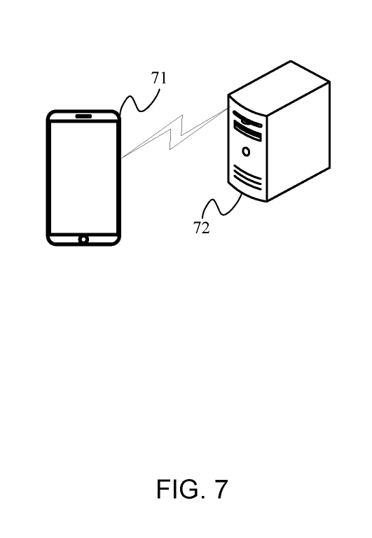

Referring to FIG. 7, a structural schematic diagram of an information processing system according to an embodiment is disclosed. The system may include an electronic device 71 and a server 72.

In an embodiment, after the electronic device sends verification request information to the server, the server further obtains application identification information besides the verification code and puts the application identification information and the verification code in one data packet, i.e., the verification information, to send to the electronic device. This ensures that only the application matching the application identification information in the electronic device can read the verification information and obtain the corresponding verification code, thereby preventing leakage of personal information and damage to property of the user caused by a malicious application stealing the verification code.

At last, it should be noted that, in the aforementioned embodiments, terms “comprises”, “comprising”, “has”, “having”, “includes”, “including”, “contains”, “containing” or any other variation thereof, are intended to cover a non-exclusive inclusion, such that a process, method, or system, that comprises, has, includes, contains a list of elements does not include only those elements, but may include other elements not expressly listed or inherent to such process, method, or system. An element defined by the phrase “comprises a . . . ” does not, without more constraints, preclude the existence of additional identical elements in the process, method, or system that comprises the element.

The embodiments in this specification have been described in a progressive manner. What is emphasized in each embodiment is its differences from other embodiments. Identical or similar features across the embodiments can be identified by cross referencing. For the products, i.e., the electronic device, the server, and the system, disclosed in the embodiments, the descriptions are relatively brief as they correspond to the corresponding methods disclosed in the embodiments. Please refer to the description of the corresponding methods for relevant points.

The foregoing description of the disclosed embodiments enables a person skilled in the art to implement or use the present invention. Various modifications to the embodiments are obvious to the person skilled in the art, and general principles defined in this description may be implemented in other embodiments without departing from the spirit or scope of the present invention. Therefore, the present invention will not be limited to the embodiments described in this description, but extends to the widest scope that complies with the principles and novelty disclosed in this description.

What is claimed is:

1. A method, comprising:
identifying an attempt to access an application installed on an information handling device;
receiving, in response to the attempt to access the application, a coded data set at the information handling device;
identifying a target application associated with the coded data set; and
causing the target application to access the coded data set.

2. The method of claim 1, wherein the coded data set comprises application identification information and a verification code.

3. The method of claim 2, wherein the identifying a target application comprises identifying a target application associated with the application identification information.

4. The method of claim 2, wherein the application identification information comprises a target application signature.

5. The method of claim 4, wherein the identifying a target application comprises comparing the target application signature to a plurality of applications to determine the target application.

6. The method of claim 2, wherein the application identification information comprises a target application package name.

7. The method of claim 6, wherein the identifying a target application comprises comparing the target application package name to a plurality of applications to determine the target application.

8. The method of claim 1, wherein the coded data set is received from a data server.

9. The method of claim 8, further comprising requesting verification data from the data server.

10. The method of claim 9, wherein the requesting comprises automatically requesting verification data when the target application is initiated.

11. An information handling device, comprising:
a processor;
a memory device that stores instructions executable by the processor to:
identify an attempt to access an application installed on an information handling device;
receive, in response to the attempt to access the application, a coded data set at the information handling device;
identify a target application associated with the coded data set; and
cause the target application to access the coded data set.

12. The information handling device of claim 11, wherein the coded data set comprises application identification information and a verification code.

13. The information handling device of claim 12, wherein the instructions executable by the processor to identify a target application further comprise instructions executable by the processor to identify a target application associated with the application identification information.

14. The information handling device of claim 12, wherein the application identification information comprises a target application signature.

15. The information handling device of claim 14, wherein the instructions executable by the processor to identify a target application further comprise instructions executable by the processor to compare the target application signature to a plurality of applications to determine the target application.

16. The information handling device of claim 12, wherein the application identification information comprises a target application package name.

17. The information handling device of claim 16, wherein the instructions executable by the processor to identify a target application further comprise instructions executable by the processor to compare the target application package name to a plurality of applications to determine the target application.

18. The information handling device of claim 11, wherein the coded data set is received from a data server.

19. The information handling device of claim 18, wherein the instructions are further executable by the processor to automatically request verification data from the data server when the target application is initiated.

20. A product, comprising:
a storage device that stores code, the code being executable by a processor and comprising:
code that identifies an attempt to access an application installed on an information handling device;
code that receives, in response to the attempt to access the application, a coded data set at the information handling device;
code that identifies a target application associated with the coded data set; and
code that causes the target application to access the coded data set.
